(19) United States
(12) Patent Application Publication
(10) Pub. No.: US 2013/0298110 A1
(43) Pub. Date: Nov. 7, 2013

(54) Software Visualization Using Code Coverage Information

(71) Applicants: Edward B. Boden, Highland, NY (US); Martin M. Fullam, New Paltz, NY (US)

(72) Inventors: Edward B. Boden, Highland, NY (US); Martin M. Fullam, New Paltz, NY (US)

(73) Assignee: INTERNATIONAL BUSINESS MACHINES CORPORATION, Armonk, NY (US)

(21) Appl. No.: 13/462,042

(22) Filed: May 2, 2012

(51) Int. Cl. G06F 11/36

(52) U.S. Cl. 717/125

(57) ABSTRACT

A method for visualization of a software program includes receiving code coverage data generated by the software program, the code coverage data being associated with a test case, by a visualization tool in a computing system; and generating, by the visualization tool, a visualization of an execution of the test case by the software program based on the code coverage data; and displaying the visualization to a user.

### BACKGROUND

This disclosure relates generally to the field of computer systems, and more particularly to visualization of software execution in a computer system.

Software programs, which are written by developers as source code that is compiled into executables that are run on a computer system, may be relatively large and complex. A software program may have many different developers making contributions and changes to the software program throughout a multi-release lifecycle, for example, while the code is under active development, during testing, or after deployment of the software as a stable code base. A developer, test engineer, or service person may need to come to an understanding of the structure and operation of a software program quickly and effectively in order to make contributions or changes to a software program.

Understanding of the structure and operation of a software program is also important for other applications, such as reverse engineering of a software program or evolving and maintaining software intensive computing systems or software products over time. There are many other examples of such applications. A service team may need to service program code that was written by others, or a new developer may be brought in to work on an existing product. Product maintenance of a software program may be transferred to a new development team. Significant new enhancements may be needed for a mature software program product. A software program may need to be ported to a new platform or operating system environment, or two more software products may need to be merged or integrated into one. In addition to the above examples, a software development team has on ongoing need to understand the code that the software development team is writing as the code progresses, which may be challenging with a relatively large code base. Development and service teams may also require debugging tools in order to test the code base.

Various tools are available to developers and test engineers to help them gain understanding of a software program, such as syntax highlighting in text editors that display the code and integrated development environments (IDEs), which may have many plug-in tools to aid software development. However, even with such tools, the ability of individuals to learn and understand a software program may be challenged by a relatively large, complex software program.

### BRIEF SUMMARY

In one aspect, a method for visualization of a software program includes receiving code coverage data generated by the software program, the code coverage data being associated with a test case, by a visualization tool in a computing system; and generating, by the visualization tool, a visualization of an execution of the test case by the software program based on the code coverage data; and displaying the visualization to a user.

In another aspect, a computer program product comprising a computer readable storage medium containing computer code that, when executed by a computer, implements a method for visualization of a software program, wherein the method includes receiving code coverage data generated by the software program, the code coverage data being associated with a test case, by a visualization tool in a computing system; and generating, by the visualization tool, a visualization of an execution of the test case by the software program based on the code coverage data; and displaying the visualization to a user.

A computer system for visualization of a software program includes a code coverage tool configured to insert code coverage data into source code associated with the software program; a build tool configured to build the source code with the inserted code coverage data into an instrumented executable of the software program, wherein the instrumented executable is configured to execute a test case and output code coverage data associated with the test case; a visualization tool configured to receive the code coverage data associated with the test case and generate a visualization of an execution of the test case by the software program based on the code coverage data; and a display configured to display the visualization generated by the visualization tool to a user.

Additional features are realized through the techniques of the present exemplary embodiment. Other embodiments are described in detail herein and are considered a part of what is claimed. For a better understanding of the features of the exemplary embodiment, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 illustrates a flowchart of an embodiment of a method for visualization of software using code coverage information.

FIG. 2 illustrates an embodiment of a system for visualization of software using code coverage information.

FIGS. 3A-3G illustrate an embodiment of a visualization for a test case.

FIGS. 4A-4E illustrate another embodiment of a visualization for test case.

FIG. 5 illustrates another embodiment of a visualization for test case.

FIG. 6 illustrates schematic block diagram of a computer that may be used in conjunction with systems and method for visualization of software using code coverage information.

### DETAILED DESCRIPTION

Embodiments of systems and methods for visualization of software using code coverage information are provided, with exemplary embodiments being discussed below in detail. Specific test cases may be associated with code coverage information, and a user may view the execution of a selected test case as the test case is executed by the code using a visualization tool. Code coverage information may comprise checkpoints that are automatically inserted by a code coverage tool between each line of the source code of the software so that it may be determined what percentage of the lines of source code have been executed by a particular test case. The visualization tool may automatically generate end-to-end software product information at varying levels of scale (i.e., software abstraction) using the code coverage information, which may improve speed and depth of software understanding by a user. The internal dynamics of the software on a per test case basis may be displayed to the user by the visualization tool. Because the visualization is automatically generated based on the code coverage information instead of live execution of the test case by the software, the visualization may be run at a speed that is independent of the run time of the test case. A test case may be related to any user story, use case, or usage scenario (i.e., a sequence of user stories or use cases). The user may also compare execution of the software across different test cases, or view execution of different builds of the software for the same test case, which may be used for problem diagnosis.

In an example visualization, the source code of the software may be displayed in the visualization tool. The visualization tool may display the source code in a static or animated representation in various embodiments. An animated visualization may highlight parts of the source code in the sequence in which they are executed. The user may invoke a step mode, in which each statement that is executed during execution of the test case is highlighted in turn based on user input, such as, for example, repeatedly invoking a “next” function, in some embodiments. In other embodiments the user may turn on an auto-play option at any desired pace. The user may thereby watch the execution of the selected test case at it proceeds through the code. The user may move forward or backward through the source code in the visualization, as desired; such functionality may not be available through interactive debugging systems.

The visualization tool may be used to replay a given visualization with selected parameters in order to better see the sequence and interactions of the test case execution. A complete set of parameters of a visualization (for example, use cases, test case drivers, logical scale of code, time scale, and any other characteristics), may be saved for later replay. The visualization tool may also allow the user to visually compare the behavior for a test case with a previous build that was known to work, with the visualized behavior for the test case with a new build that has some apparent defect, in order to identify the source of the defect, which may aid in debugging. Results for any number of test cases may be saved, examined, and compared.

The visualization tool may display the source code at varying levels of scale, as desired by the user, and jump between the various levels of scale. The various levels may include but are not limited to source line-of-code level, block level, entry-point or class/method level, file level, and component level. The visualization tool may mask or filter out selected elements of the visualization at various levels of scale; for example, the visualization tool may skip over certain classes, files, or components in the source code if requested by the user. The visualization tool may also display the source code at a business requirement level, as user stories may be directly mapped to product requirements. Therefore, for a selected user story, use case, or usage scenario, the requirement line items that were tested by the test case may be highlighted.

The visualization tool may be provided in any appropriate manner, including but not limited to as a plugin for an IDE (for example, Eclipse or Rational Software Architect). The visualization tool may be used in conjunction with code that is written in any programming language. The code coverage information used to drive the visualization tool is automatically generated, and may be automatically recreated for each build of the software. The visualization tool may also be used in conjunction with software executables for which the source code is not available; in such an embodiments, the executable segments, for example, dynamic linked libraries (dlls), open services gateway initiative (OSGi) packages, java archives (jars), etc., associated with execution of the test case in the software may be highlighted and stepped through.

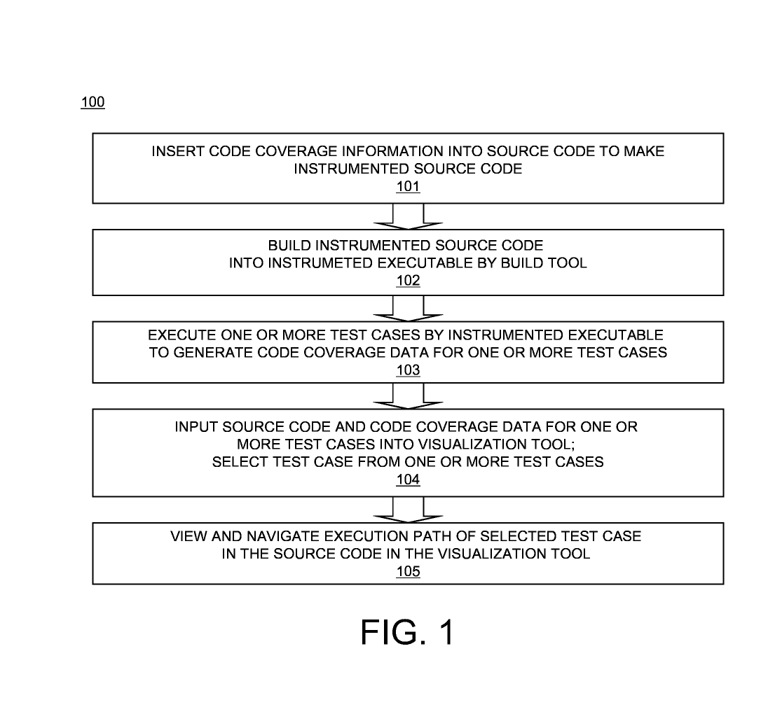

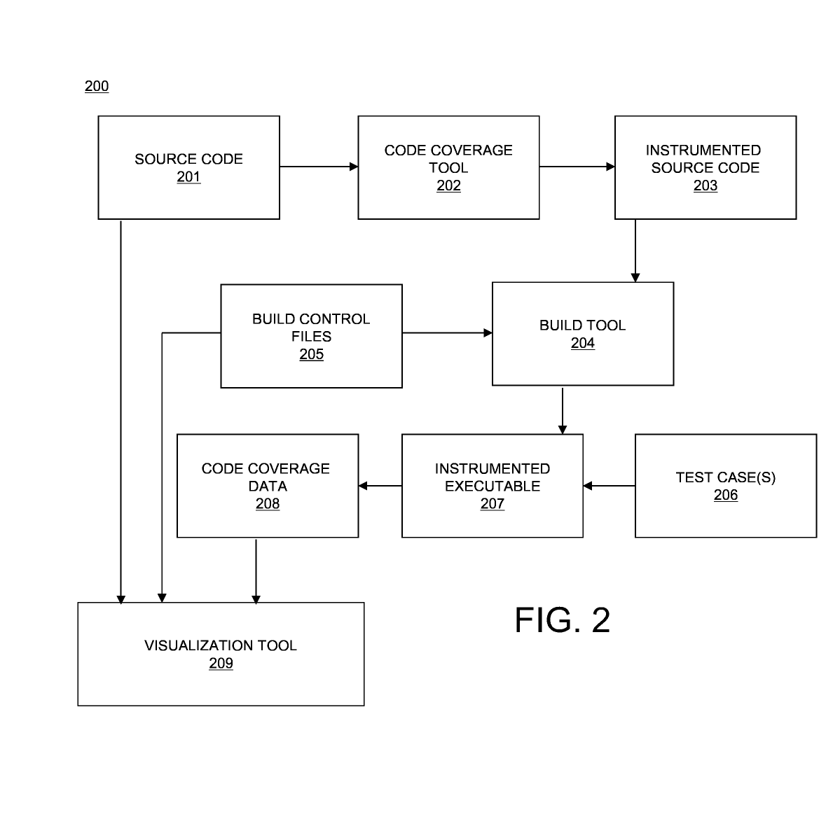

FIG. 1 illustrates a flowchart of an embodiment of a method 100 for test case simulation for software using code coverage information, and FIG. 2 shows an embodiment of a system 200 for test case simulation for software using code coverage information. FIG. 1 is discussed with respect to FIG. 2. System 200 of FIG. 2 includes source code 201, which may be source code that is written in any appropriate computer language(s) and code coverage tool 202, which may include any appropriate code coverage tool for the computer language in which source code 201 is written. First, in block 101, the code coverage tool 202 creates instrumented code 203 of the source code 201 by inserting code coverage information into the source code 201. The code coverage information that is inserted into source code 201 to create instrumented code 203 may include any appropriate code coverage information format, such as checkpoints that are inserted between lines of source code. Any appropriate amount and format of code coverage information may be inserted into the source code 201 by code coverage tool 202 to create instrumented code 203. The code coverage information may include, for example, the file name and line number for each checkpoint.

Next, in block 102, the instrumented code 203, which comprises the source code 201 with the code coverage information from the code coverage tool 202 inserted, is compiled by build tool 204 to build an instrumented executable 207 of the instrumented code 203. The build tool 204 may be any appropriate compiler for the language in which source code 201 is written. Build control files 205, which may include, for example, libraries of the computing language in which source code 201 is written and packaging information may be used by build tool 204 during the build. The instrumented code 203 includes the checkpoints that comprise the code coverage information.

Then, in block 103, one or more test cases 206 are executed using the instrumented executable 207 to generate code coverage data 208. The one or more test cases 206 may comprise any appropriate number of test cases, and may comprise any appropriate types of test case, for example, a user story, a user case, or a usage scenario, in various embodiments. The instrumented executable 207 is executed for the one or more test cases 206 sequentially with code coverage enabled to generate the code coverage data 208. The code coverage data 208 comprises checkpoint information, which may comprise, in some embodiments, a file name and/or line number for each checkpoint that is traversed during execution of the one or more test cases 206 by instrumented executable 207. In other embodiments, the code coverage data may comprise a line of data per source code file that was executed for each time an entry point of the source code file was invoked. That is, if an entry point to a source code file is invoked multiple times, each invocation is a separate output line, and each output line may contain information such as file name, date/time stamp, entry point name, and an ordered sequence of the line numbers that were executed. The lines of code coverage data generated during execution of a particular test case of one or more test cases 206 are associated with the particular test case using, for example, a unique identifier corresponding to the particular test case, or saved in a single file associated with the particular test case. An example logical format for code coverage data 208 that is generated in block 103 of FIG. 1 may be:

{test case,{file name,line number+}+}+,

where + indicates 1 or more occurrences. The order of line numbers is the order of execution of the lines of source code, with separate entries for line repetitions, and the order of the {file name, line number+} component reflects the order of files as executed, also with separate entries repetitions. However, some embodiments of code coverage tools may support raw output with this full detail, while others do not. Therefore, in an embodiment in which line repetitions are not shown within a code coverage data file, a stepped visualization (discussed in further detail below) within a source code file may not be generated.

Flow then proceeds to block 104, in which the source code 201, code coverage data 208, and the build control files 205 are input into the visualization tool 209. The visualization tool 209 determines a list of the one or more test cases 206 for which code coverage data 208 is available. A list of one or more test cases 206 may be shown to a user with the ones having coverage data shown as selectable in some embodiments, and the user may then select a particular test case to view in the visualization tool 209. In embodiments in which one or more test cases 206 comprises a single test case, the single test case is the selected test case.

Lastly, in block 105, the user views the execution path of the selected test case by the source code 201 in the visualization tool 209. The visualization displayed by visualization tool 209 may by animated or static in various embodiments. The visualization displayed by visualization tool 209 is generated for the selected test case based on the code coverage data 208 associated with the selected test case. The code coverage data 208 may indicate to visualization tool 209 the sequence of lines, or sequence of higher level elements such as classes, in the source code 201 that were executed by the selected test case.

In some embodiments, the visualization in visualization tool 209 may be shown at the file level, and the user is shown an ordered sequence representation of source code files with names and is prompted to select one, or to proceed with the first source code file that contains code that was executed by the test case. The source code files are shown based on the code coverage data for the selected test case. The visualization starts with the selected file; if the selected file is not the first source code file, preceding source code files are skipped. The visualization may show statistics for the source code file, such as the number of executable lines, number of line executed, and data about recent update (for example, date, time, committer identity, etc.). The user may hit enter to go to the next file, or zoom into the current file to view the source code. When viewed at the source code level, the line of code that was first executed in the file may be highlighted; other executable lines may be, for example, black, and non-executable lines may be, for example, grayed out. The user may step through each line of code that was executed by the test case, or may select an auto play option such that next executed line of code will advance at a default pace, or at any appropriate pace set by the user. As execution moves from one source code file to another in auto mode, a longer pause may be made between files, showing both the last executed line of code in the current file and the next executed line of code in the next file. At any time the user may change the level of detail that is shown in the visualization tool 209, moving up or down thru the available levels, such as line of code, block, entry point or class/method, file, or component.

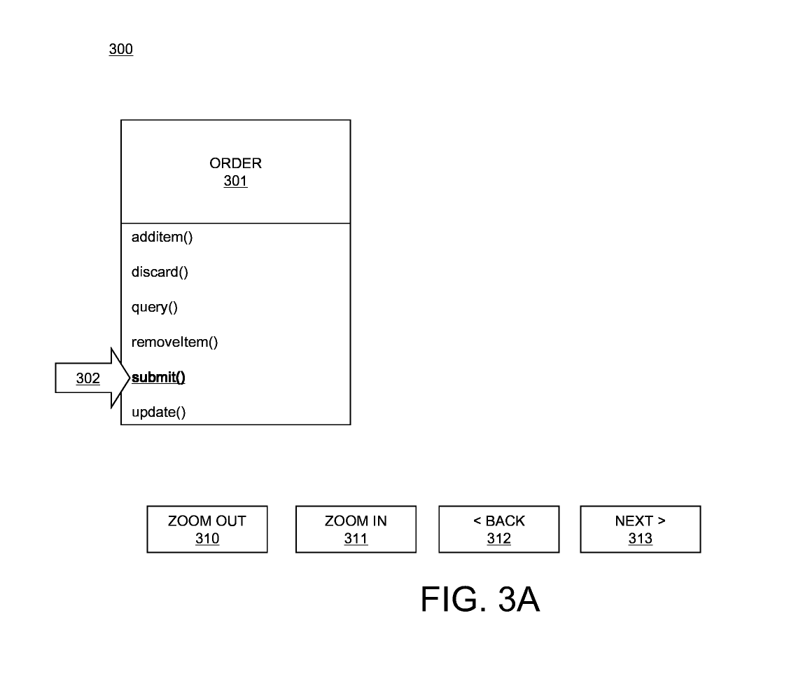

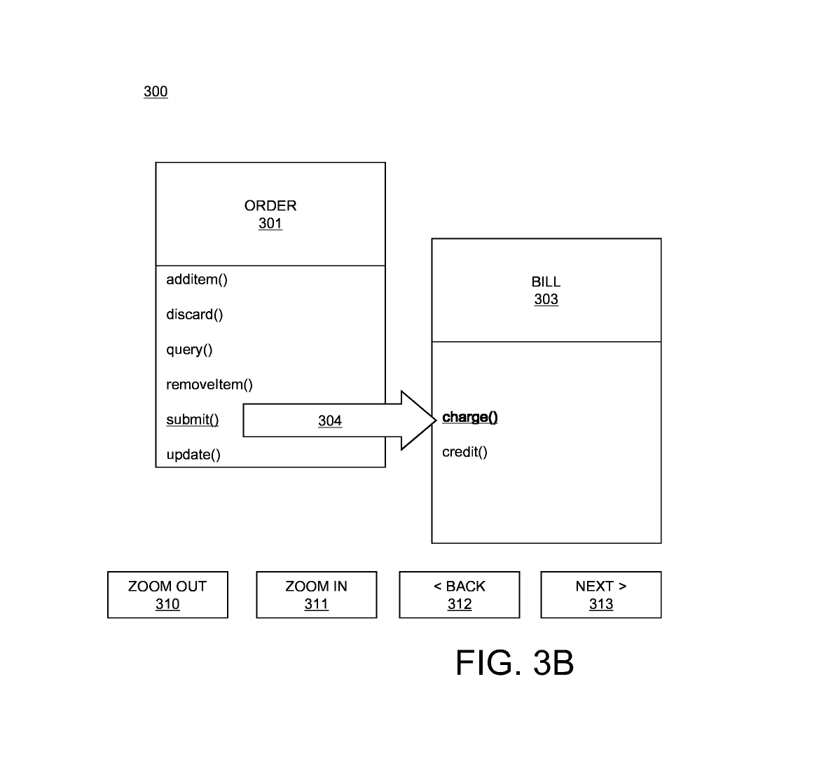

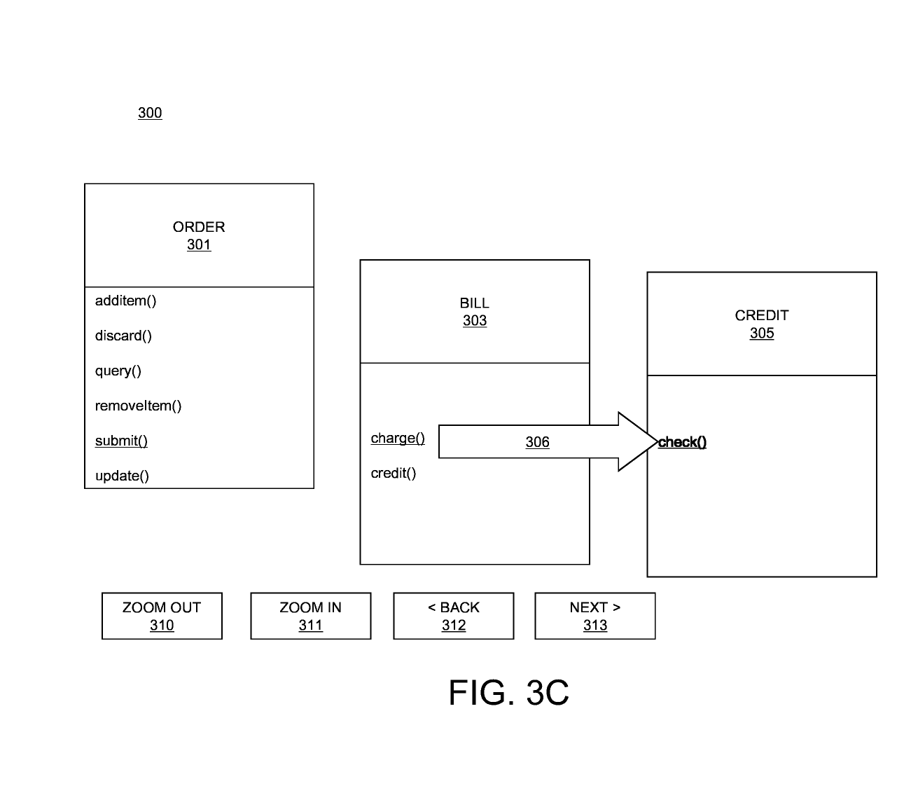

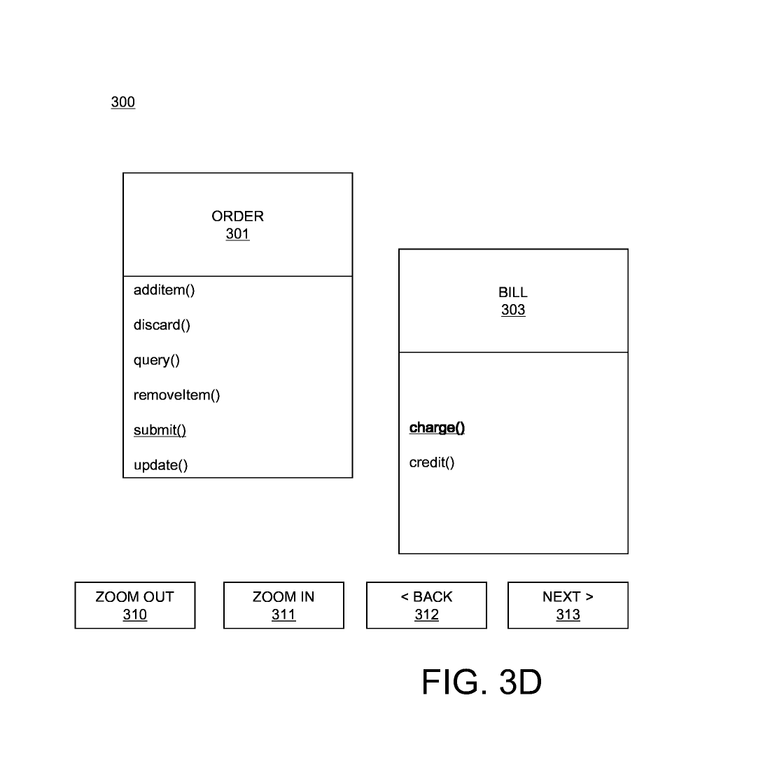

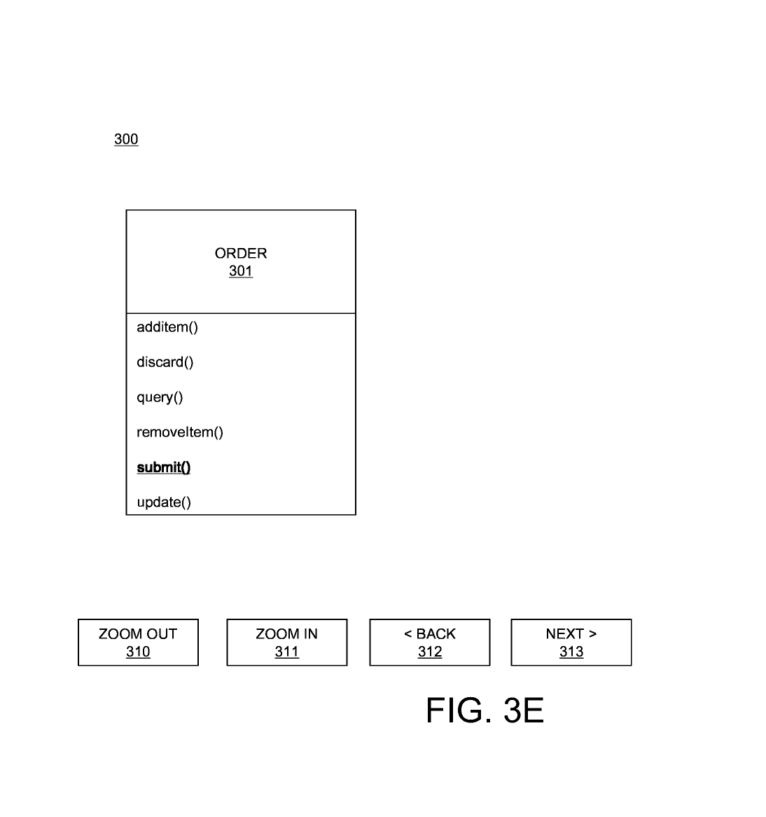

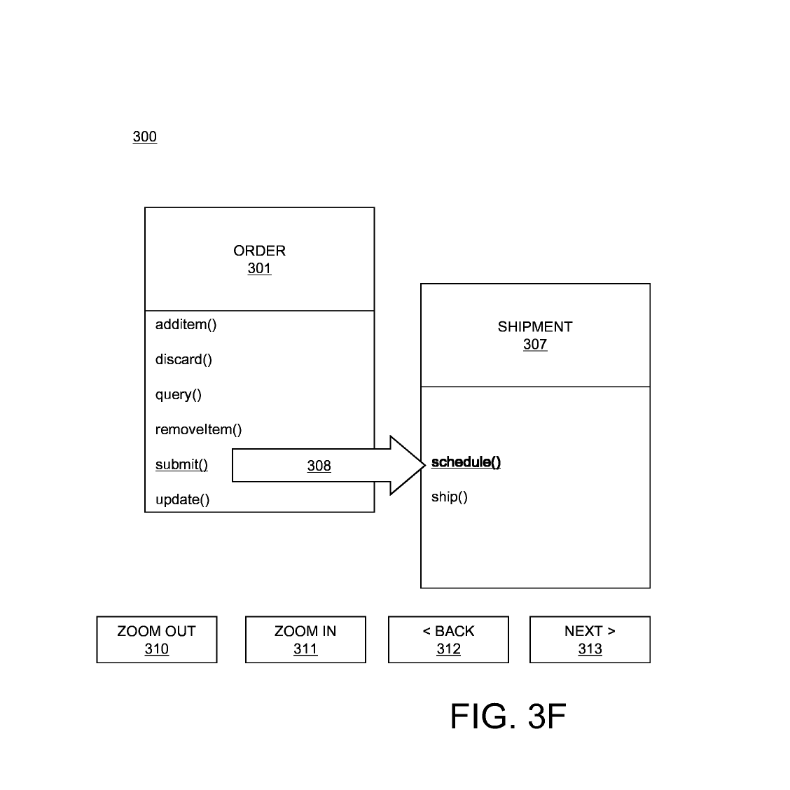

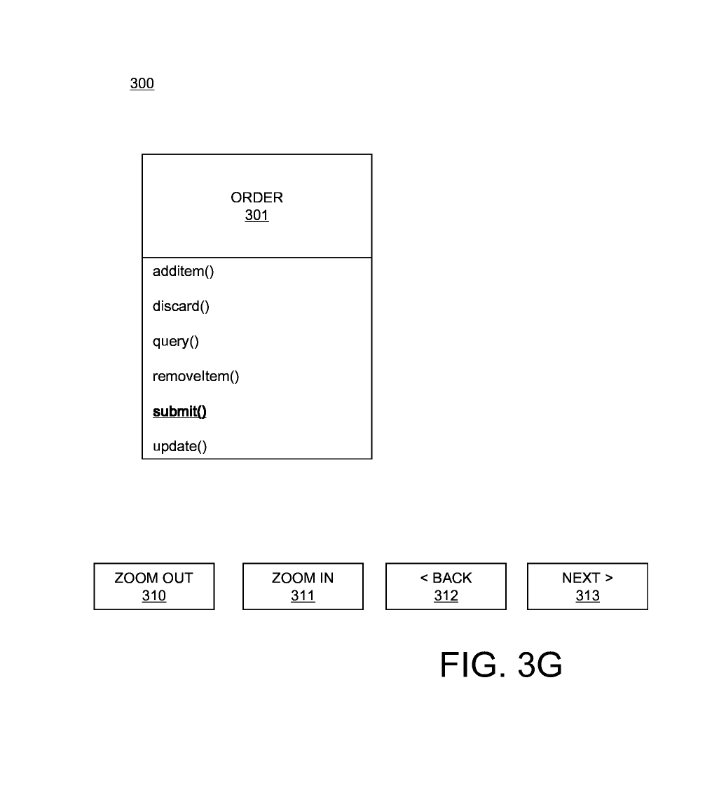

Various embodiments of visualizations that may be displayed by the visualization tool 209 during block 105 of FIG. 1 are shown in FIGS. 3A-3G, FIGS. 4A-4E, and FIG. 5. FIGS. 3A-3G show a first embodiment of an animated simulation 300 that may be displayed during block 105 of FIG. 1 by visualization tool 209. The simulation 300 of the selected test case begins with a call to the submit( ) method, as indicated by arrow 302, of the Order class 301 with can be found in Customer.java (com.ibm.retail.pos.Customer.java), as shown in FIG. 3A. Clicking the next button 313 allows the user to step forwards in execution of the test case, and back button 312 allows the user to step backwards. Additionally, the user may zoom in or out via buttons 310 and 311 to see more or less detail. For example, from the class/method view, could zoom in to step through blocks or individual lines of code; could zoom out and watch the test case progress in and out of source code files or components. When the user clicks the next button 313 in FIGS. 3A-3G, the visualization tool 209 to renders the sequence of calls to methods in other classes in order, and while indicating which java files the calls are in. From FIG. 3A, the visualization tool 209 proceeds to FIG. 3B, where the submit( ) method of Order class 301 calls the charge( ) method of Bill class 303, as indicated by arrow 304. Clicking the next button 313 in FIG. 3B then shows the charge( ) method of Bill class 303 calling the check( ) method of Credit class 305, as indicated by arrow 306 in FIG. 3C. From FIG. 3C, clicking the next button 313 again shows the execution of the test case after completion of the check( ) method of Credit class 305, at which point execution proceeds back to the charge( ) method in Bill class 303 in FIG. 3D. Then the charge( ) method in Bill class 303 completes, and execution proceeds back to the submit( ) method in Order class 301 as shown in FIG. 3E. Then, as shown in FIG. 3F, the submit( ) method in Order class 301 calls the schedule( ) method in Shipment class 307 as indicated by arrow 308. Lastly, the execution of the schedule( ) method in Shipment class 307 completes, and execution returns to submit( ) method in Order class 301 as shown in FIG. 3G.

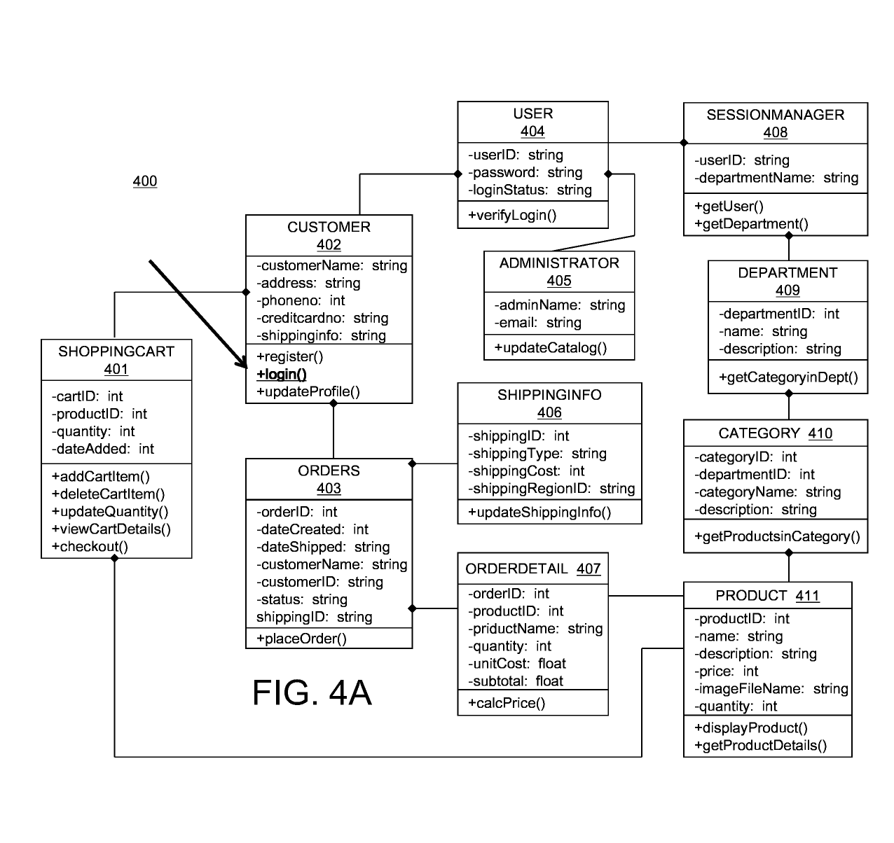

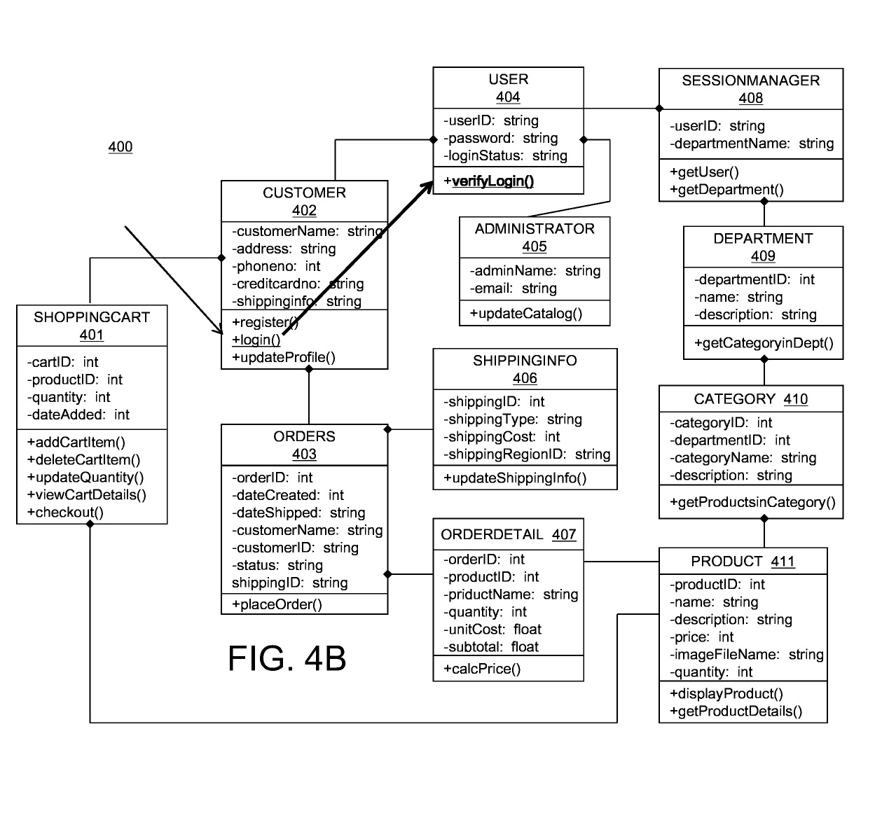

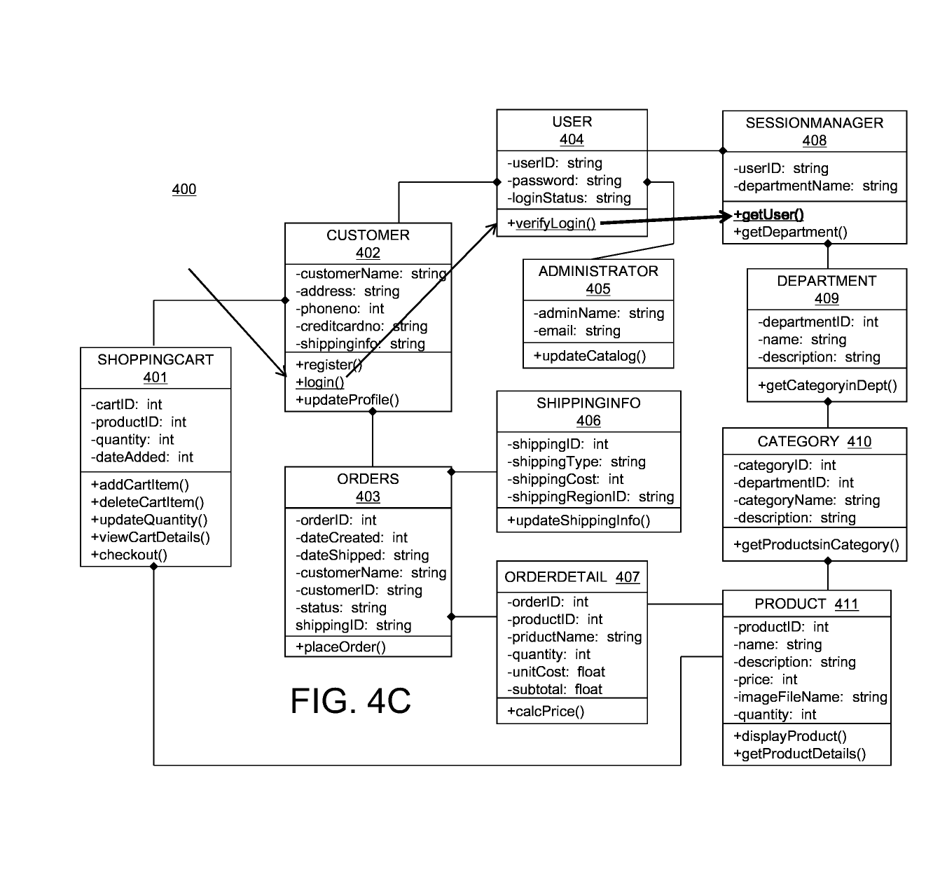

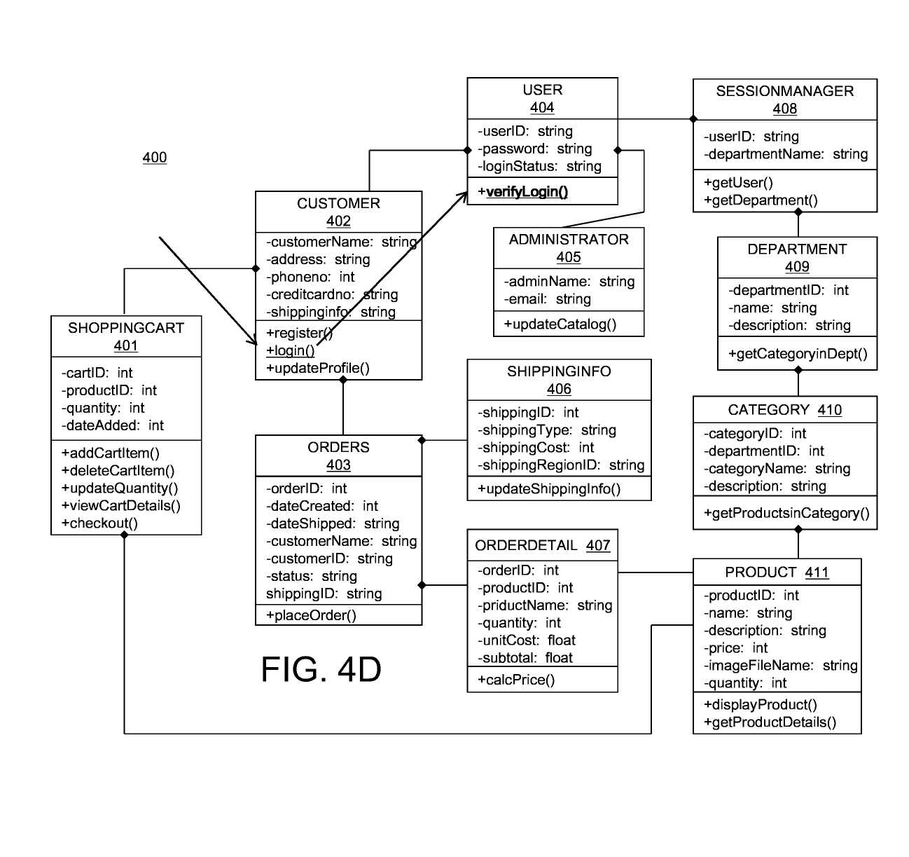

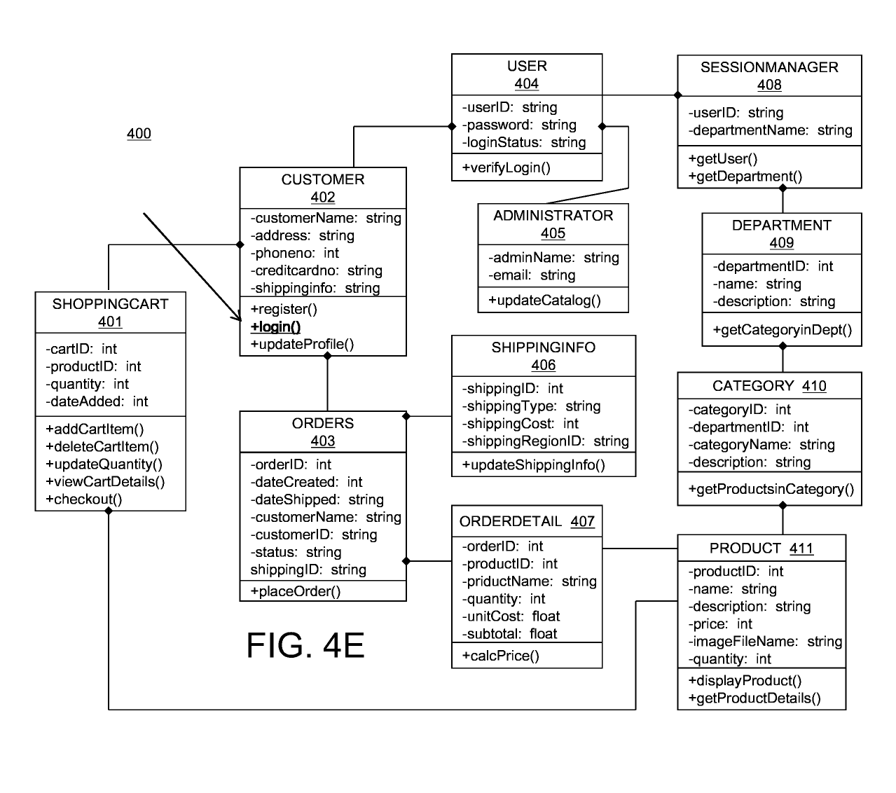

FIGS. 4A-4E show a second embodiment of a simulation that may be displayed by visualization tool 209 in block 105 that comprises an animated class/method view using a class diagram 400. The class diagram 400 includes various classes from the source code, including ShoppingCart 401, Customer 402, Orders 403, User 404, Administrator 405, ShippingInfo 406, OrderDetail 407, SessionManager 408, Department 409, Category 410, and Product 411, and also shows variables and methods belonging to each class, in addition to relationships between the classes. As shown in FIG. 4A, the test case starts at the login( ) method of the Customer class 402. Then, as shown in FIG. 4B, the login( ) method of the Customer class 402 calls the verifyLogin( ) method of the User class 404. Next, as shown in FIG. 4C, the verifyLogin( ) method of User class 404 calls the getUser method of the SessionManager class 408. After the getUser( ) method of the SessionManager class 408 completes, flow returns to the verifyLogin( ) method of User class 404, as shown in FIG. 4D. Then, after the verifyLogin( ) method of User class 404 completes, flow returns to the login( ) method of the Customer class 402 as shown in FIG. 4E.

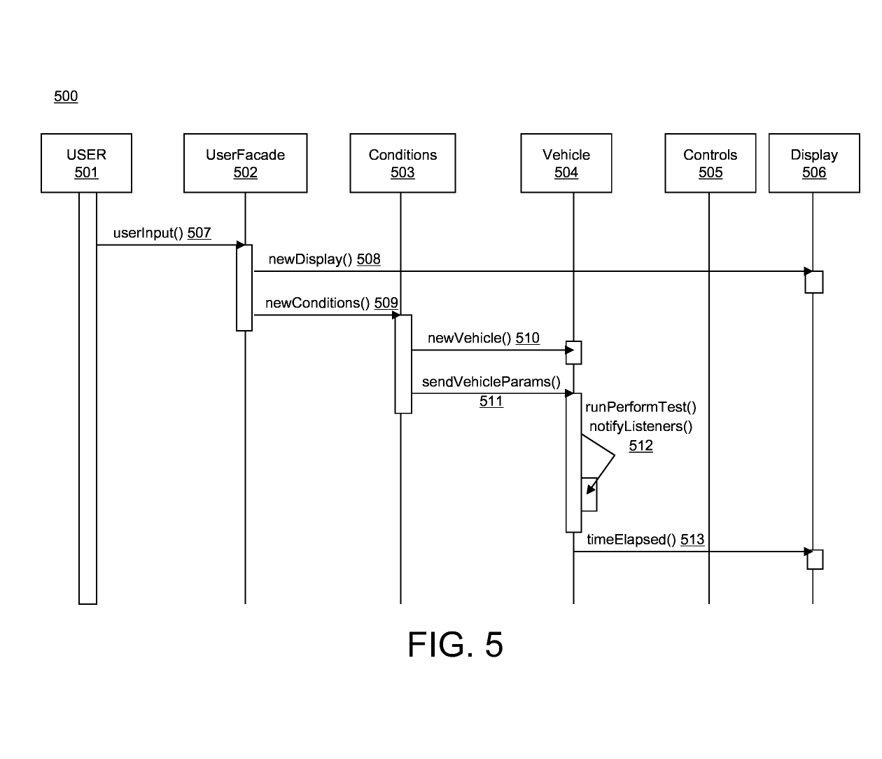

FIG. 5 shows another embodiment of a class/method flow for a given test case in a static sequence diagram 500 that may be displayed by visualization tool 209 during block 105 of FIG. 1. Unlike the embodiments of FIGS. 3A-3G and FIGS. 4A-4E, the static sequence diagram 500 of FIG. 5 does not require animation. User object 501 calls various classes, including userFacade 502, Conditions 503, Vehicle 504, Controls 505, and Display 506 are shown, and the methods and calls between the user object 501 and the various classes 502-506 are indicated by arrows 507-513. First, user object 501 calls userInput( ) method 507 in userFacade class 502. The userInput( ) method 507 then calls newDisplay( ) method 508 in Display class 506 and newConditions( ) method 509 in Conditions class 503. The newConditions( ) method 509 calls newVehicle( ) method 510 and sendVehicleParams( ) method 511 in Vehicle class 504. The sendVehicleParams( ) method 511 in Vehicle class 504 then calls runPerformTest( ) and notifyListers( ) in Vehicle class 504, as indicated by arrow 502, and the timeElapsed( ) method 513 in Display 506. The interactions for the test case are thereby shown in the sequence diagram 500 of FIG. 5.

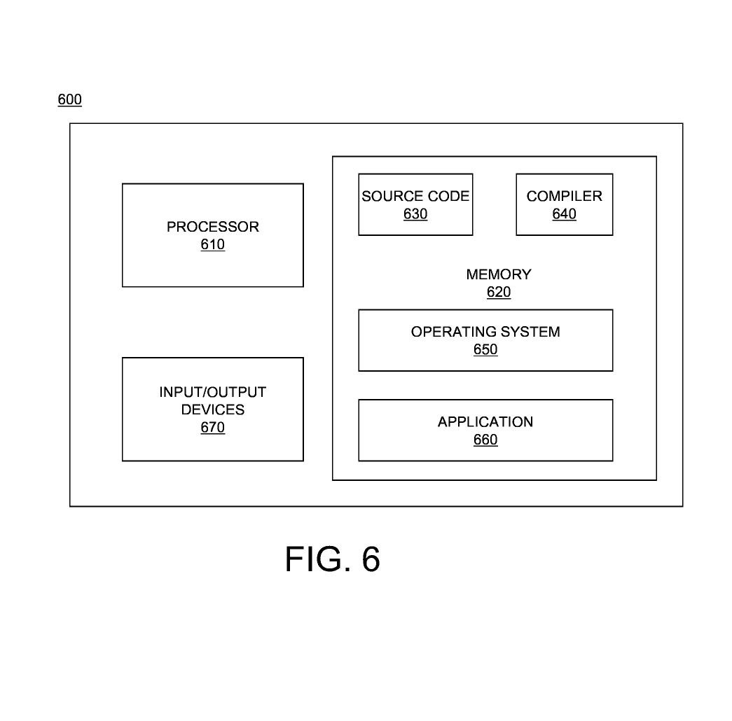

FIG. 6 illustrates an example of a computer 600 which may be utilized by exemplary embodiments of systems and methods for test case visualization using code coverage information as embodied in software. Various operations discussed above may utilize the capabilities of the computer 600. One or more of the capabilities of the computer 600 may be incorporated in any element, module, application, and/or component discussed herein.

The computer 600 includes, but is not limited to, PCs, workstations, laptops, PDAs, palm devices, servers, storages, and the like. Generally, in terms of hardware architecture, the computer 600 may include one or more processors 610, memory 620, and one or more input and/or output (I/O) devices 670 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 610 is a hardware device for executing software that can be stored in the memory 620. The processor 610 can be virtually any custom made or commercially available processor, a central processing unit (CPU), a digital signal processor (DSP), or an auxiliary processor among several processors associated with the computer 600, and the processor 610 may be a semiconductor based microprocessor (in the form of a microchip) or a macroprocessor.

The memory 620 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 620 may incorporate electronic, magnetic, optical, and/or other types of storage media. Note that the memory 620 can have a distributed architecture, where various components are situated remote from one another, but can be accessed by the processor 610.

The software in the memory 620 may include one or more separate programs, each of which comprises an ordered listing of executable instructions for implementing logical functions. The software in the memory 620 includes a suitable operating system (O/S) 650, compiler 640, source code 630, and one or more applications 660 in accordance with exemplary embodiments. As illustrated, the application 660 comprises numerous functional components for implementing the features and operations of the exemplary embodiments. The application 660 of the computer 600 may represent various applications, computational units, logic, functional units, processes, operations, virtual entities, and/or modules in accordance with exemplary embodiments, but the application 660 is not meant to be a limitation.

The operating system 650 controls the execution of other computer programs, and provides scheduling, input-output control, file and data management, memory management, and communication control and related services. It is contemplated by the inventors that the application 660 for implementing exemplary embodiments may be applicable on all commercially available operating systems.

Application 660 may be a source program, executable program (object code), script, or any other entity comprising a set of instructions to be performed. When a source program, then the program is usually translated via a compiler (such as the compiler 640), assembler, interpreter, or the like, which may or may not be included within the memory 620, so as to operate properly in connection with the O/S 650. Furthermore, the application 660 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 670 may include input devices such as, for example but not limited to, a mouse, keyboard, scanner, microphone, camera, etc. Furthermore, the I/O devices 670 may also include output devices, for example but not limited to a printer, display, etc. Finally, the I/O devices 670 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 670 also include components for communicating over various networks, such as the Internet or intranet.

If the computer 600 is a PC, workstation, intelligent device or the like, the software in the memory 620 may further include a basic input output system (BIOS) (omitted for simplicity). The BIOS is a set of essential software routines that initialize and test hardware at startup, start the O/S 650, and support the transfer of data among the hardware devices. The BIOS is stored in some type of read-only-memory, such as ROM, PROM, EPROM, EEPROM or the like, so that the BIOS can be executed when the computer 600 is activated.

When the computer 600 is in operation, the processor 610 is configured to execute software stored within the memory 620, to communicate data to and from the memory 620, and to generally control operations of the computer 600 pursuant to the software. The application 660 and the O/S 650 are read, in whole or in part, by the processor 610, perhaps buffered within the processor 610, and then executed.

When the application 660 is implemented in software it should be noted that the application 660 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 660 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 660 is implemented in hardware, the application 660 can be implemented with any one or a combination of the following technologies, which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The technical effects and benefits of exemplary embodiments include automatic provision of a detailed view of the execution of a software program to a user, so as to increase user understanding of the software program.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for visualization of a software program, the method comprising:
receiving code coverage data generated by the software program, the code coverage data being associated with a test case, by a visualization tool in a computing system; and
generating, by the visualization tool, a visualization of an execution of the test case by the software program based on the code coverage data; and
displaying the visualization to a user.

2. The method of claim 1, wherein the code coverage data is generated by:
inserting code coverage information into source code of the software program by a code coverage tool;
building the source code with the inserted code coverage information into an instrumented executable of the software program;
executing the test case by the instrumented executable, wherein the execution outputs the code coverage data associated with the test case.

3. The method of claim 2, wherein the code coverage information comprises a plurality of checkpoints inserted between respective lines in the source code.

4. The method of claim 2, wherein the code coverage data comprises file name and line number information for lines of the source code that are executed during execution of the test case.

5. The method of claim 1, further comprising:
receiving code coverage data generated by the software program for a plurality of test cases;
selecting a test case by a user; and
generating, by the visualization tool, a visualization of an execution of the selected test case by the software program based on the code coverage data associated with the selected test case.

6. The method of claim 1, further comprising:
receiving first code coverage data generated by a first build of the software program for a test case;
receiving second code coverage data generated by a second build of the software program for the test case, wherein the second build of the software program contains an error;
generating, by the visualization tool, a first visualization of an execution of the test case by the first build of the software program based on the first code coverage data;
generating, by the visualization tool, a second visualization of an execution of the test case by the second build of the software program based on the second code coverage data; and
displaying the first visualization and the second visualization to the user.

7. The method of claim 1, further comprising zooming from a first level of detail to a second level of detail in the visualization by the user.

8. The method of claim 7, wherein the first and second levels of detail each comprise one of: source line-of-code level, block level, entry-point or class/method level, file level, and component level.

9. The method of claim 1, wherein the visualization is animated.

10. The method of claim 9, wherein the animated visualization comprises a class diagram of the software program.

11. The method of claim 1, wherein the visualization is static and comprises a sequence diagram of the software program.

12. A computer program product comprising a computer readable storage medium containing computer code that, when executed by a computer, implements a method for visualization of a software program, wherein the method comprises:
receiving code coverage data generated by the software program, the code coverage data being associated with a test case, by a visualization tool in a computing system; and
generating, by the visualization tool, a visualization of an execution of the test case by the software program based on the code coverage data; and
displaying the visualization to a user.

13. The computer program product according to claim 12, wherein the code coverage data is generated by:
inserting code coverage information into source code of the software program by a code coverage tool;
building the source code with the inserted code coverage information into an instrumented executable of the software program;
executing the test case by the instrumented executable, wherein the execution outputs the code coverage data associated with the test case.

14. The computer program product according to claim 13, wherein the code coverage information comprises a plurality of checkpoints inserted between respective lines in the source code.

15. The computer program product according to claim 13, wherein the code coverage data comprises file name and line number information for lines of the source code that are executed during execution of the test case.

16. The computer program product according to claim 12, further comprising:
receiving code coverage data generated by the software program for a plurality of test cases;
selecting a test case by a user; and
generating, by the visualization tool, a visualization of an execution of the selected test case by the software program based on the code coverage data associated with the selected test case.

17. The computer program product according to claim 12, further comprising:
receiving first code coverage data generated by a first build of the software program for a test case;
receiving second code coverage data generated by a second build of the software program for the test case, wherein the second build of the software program contains an error;
generating, by the visualization tool, a first visualization of an execution of the test case by the first build of the software program based on the first code coverage data;
generating, by the visualization tool, a second visualization of an execution of the test case by the second build of the software program based on the second code coverage data; and
displaying the first visualization and the second visualization to the user.

18. The computer program product according to claim 12, further comprising zooming from a first level of detail to a second level of detail in the visualization by the user.

19. The computer program product according to claim 18, wherein the first and second levels of detail each comprise one of: source line-of-code level, block level, entry-point or class/method level, file level, and component level.

20. A computer system for visualization of a software program, the computer system comprising:
a code coverage tool configured to insert code coverage data into source code associated with the software program;
a build tool configured to build the source code with the inserted code coverage data into an instrumented executable of the software program, wherein the instrumented executable is configured to execute a test case and output code coverage data associated with the test case;
a visualization tool configured to receive the code coverage data associated with the test case and generate a visualization of an execution of the test case by the software program based on the code coverage data; and
a display configured to display the visualization generated by the visualization tool to a user.
